(19) United States
(12) Patent Application Publication
(10) Pub. No.: US 2005/0198678 A1
(43) Pub. Date: Sep. 8, 2005

(54) Control information file creating device, information display device, control information file creation method, and information distribution display system

(75) Inventors: Hiroaki Mise, Tokyo (JP); Toshiyuki Amaya, Saitama (JP); Makoto Takanashi, Tokyo (JP); Kazuhiro Miyamoto, Tokyo (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/028,333

(22) Filed: Jan. 4, 2005

(30) Foreign Application Priority Data
Jan. 9, 2004 (JP) 2004-004765

(51) Int. Cl. H04N 7/173; G09G 5/00

(52) U.S. Cl. 725/88; 345/619; 725/102; 725/90

(57) ABSTRACT

An information creating device that creates a control information file to play back and display a plurality of different programs includes a schedule creating unit that creates as a control information file a schedule file to successively play back and display the plurality of the programs one by one, and a menu creating unit that creates as a control information file a menu file to select one program from the plurality of programs and to play back and display the selected program. The schedule creating unit and the menu creating unit create the schedule file and the menu file such that at least part of the programs is shared mutually between the two files.

### BACKGROUND OF THE INVENTION

1) Field of the Invention

The present invention relates to a technology for playing back and displaying a plurality of pieces of information one by one at a predetermined time or in a predetermined order.

2) Description of the Related Art

In recent years, it has become common to create electronic advertisements, and to distribute them and display them on display devices of users. Some configurations allow the users to select a desired piece of information for displaying. Some other configurations display the information based on a predetermined schedule.

However, even if a user does not select the desired information to be displayed, it is sometimes desirable that the distributed information be displayed on the display device for the user. On the other hand, if the information is displayed based on a predetermined schedule, a user has no control of the display of the information.

A conventional information display device is disclosed in Japanese Patent Application Laid-Open Publication No. 2002-14754. This information display device has an operation display controlling unit that changes the information to be displayed according to operation of the touch panel, a fixed time display controlling unit that displays information when the clock shows a predetermined time, and a regular time interval display controlling unit that displays information at predetermined time intervals. After carrying out an operation of the touch panel changing display information, the fixed time display and the regular time interval display are prohibited to function for a certain time period, and display according to input operation and predetermined time rules can be carried out.

Conventional information display devices described above can carry out display according to the input operation and the predetermined time rules. However, the devices are incapable of linking information to be displayed according to the input operation with information to be displayed according to the predetermined time rules. Therefore, there has been a problem that created information materials are not sufficiently utilized. Moreover, this conventional art has not disclosed any technologies relating to preparation of a schedule and a menu of information to be displayed.

### SUMMARY OF THE INVENTION

It is an object of the present invention to at least solve the problems in the conventional technology.

A control information file creating device according to an aspect of the present invention creates a control information file to play back and display plural pieces of different display information. The control information file creating device includes a schedule file creating unit that creates as a control information file a schedule file to successively play back and display the plural pieces of display information for each piece of display information; and a menu file creating unit that creates as a control information file a menu file to select one piece of display information from the plural pieces of display information and to play back and display the selected piece of display information, wherein the schedule file creating unit and the menu file creating unit create the schedule file and the menu file such that at least part of the display information is shared by the schedule file and the menu file.

A control information file creation method according to another aspect of the present invention includes creating a schedule file to successively play back and display plural pieces of display information and a menu file to select one piece of display information from the plural pieces of display information and to play back and display the selected piece of display information as respective control information files; and creating the schedule file and the menu file such that at least part of the display information is shared by the schedule file and the menu file.

An information display device according to still another aspect of the present invention plays back and serially displays plural pieces of different display information. The information display device includes a storage unit that stores the plural pieces of display information, a schedule file to successively play back and display the plural pieces of display information based on a predetermined time setting or a predetermined order setting for each piece of display information, and a menu file that selects one piece of display information from the plural pieces of display information that are at least partly shared with the plural pieces of display information used in the schedule file and plays back and displays the selected piece of
display information; and a displaying unit that plays back and displays the plural pieces of display information based on at least one of the schedule file and the menu file.

An information distribution display system according to still another aspect of the present invention includes a control information file creating device that creates a control information file to play back and display plural pieces of different display information; and an information display device that plays back and displays the plural pieces of display information based on the control information file. The control information file creating device creates as control information files 1) a schedule file to successively play back and display the plural pieces of display information based on a predetermined time setting or a predetermined order setting for each piece of display information; and 2) a menu file to select one piece of display information from the plural pieces of the display information and to play back and display the selected piece of display information so that at least part of the display information is shared by the schedule file and the menu file. Moreover, the control information file creating device transmits the schedule file and the menu file to the information display device, which plays back, and displays the plural pieces of display information based on at least one of the received schedule file and the menu file.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 presents a structure of a presentation package handled by an information distribution display system;

FIG. 2 is an explanatory drawing of data and control information files handled by the information distribution display system;

FIG. 3 presents a system structure of the information distribution display system;

FIG. 4 is an explanatory drawing of a creation procedure for programs;

FIG. 5 is a block diagram of an information creating device;

FIG. 6 is a block diagram of an information display device;

FIG. 7 is an explanatory drawing of the contents of program display priority information;

FIG. 8 is an explanatory drawing of a method for creating a schedule file;

FIG. 9 is an explanatory drawing of a method for creating a menu file; and

FIG. 10 is a flow chart of procedures for creating the menu file and the schedule file.

### DETAILED DESCRIPTION

Exemplary embodiments of an information creating device, an information display device, and an information distribution display system according to the present invention will be explained. The present invention is not limited by this embodiment.

It is assumed in the following description that information to be displayed and played back is a program composed of information of electronic advertisements and the like. The program composed of electronic advertisements and the like is created with, for example, animated images, static images, voices, and text information. Information such as electronic advertisements is created by the information creating device (control information file creating device) and sent to information display devices over networks such as the Internet.

It is preferable for programs not only to be viewed by as many information viewers as possible, but also to be played back and displayed effectively. A viewer of the programs prefers to play back a desired program at a desired view time. On the other hand, an information provider desires to keep playing back the provided programs, which can lead to enhancement of the pulling power (i.e., the power to draw the interest of a viewer) of the advertisement.

An information playback device is provided with a function that allows playing back a program selected by a viewer from a menu screen that serves as a program menu in order to play back the program desired by the viewer. The information playback device is also provided with a function with which an information provider sets in advance a playback starting time and a playback ending time of every program so that the programs may be played back in succession based on the time settings (schedule). In addition, the information playback device usually plays back the programs according to the schedule, and when a viewer desires menu playback, the information playback device switches from schedule playback to menu playback.

When carrying out schedule playback, control information files and program files that allow schedule playback can be used. When carrying out menu playback, other control information files and program files that allow menu playback can be used. Therefore, when programs are played back in these two ways, as described above, the program files for the menu playback and the program files for the schedule playback are present, which makes the data volume large as a whole.

Accordingly, the menu file and the schedule file are created by the information creating device such that at least part of the program files are shared among a plurality of the program files used for the menu playback and a plurality of the program files used for the schedule playback, thereby allowing the program files to be played back while sharing them with each other.

For example, when a schedule file is created, a priority order for program playback is given in advance with respect to each program file, and programs having a higher-priority are preferentially set into the schedule according to the priority order when the scheduled times for playback of the programs overlap one another. Further, automatic playback buttons for menu playback are provided on the menu screen, and the automatic playback buttons are given priority order in advance based on their arrangement positions, sizes, and the like. The menu file is created by allocating a program having a high-priority for program playback to an automatic playback button having a high-priority. As described above, when at least one piece of information such as priority order for program playback exists, it is possible to create a menu file and a schedule file.

It is possible to create the schedule file and the menu file in a short time because the menu file and the schedule file share a plurality of program files used for menu playback and a plurality of program files used for schedule playback. In addition, it is possible to decrease the number of program files for carrying out the menu playback and the schedule playback.

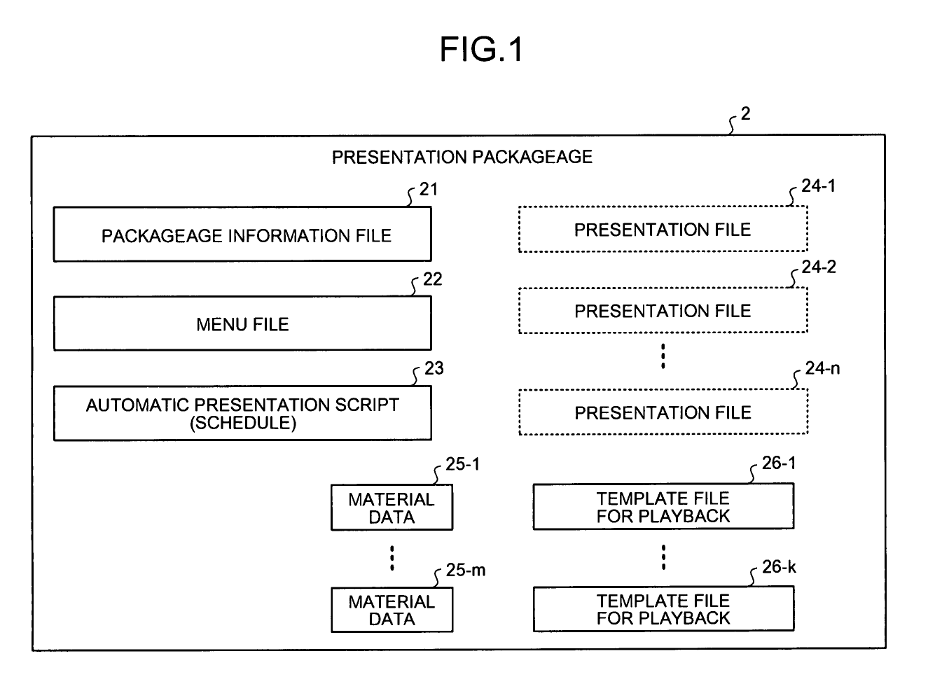

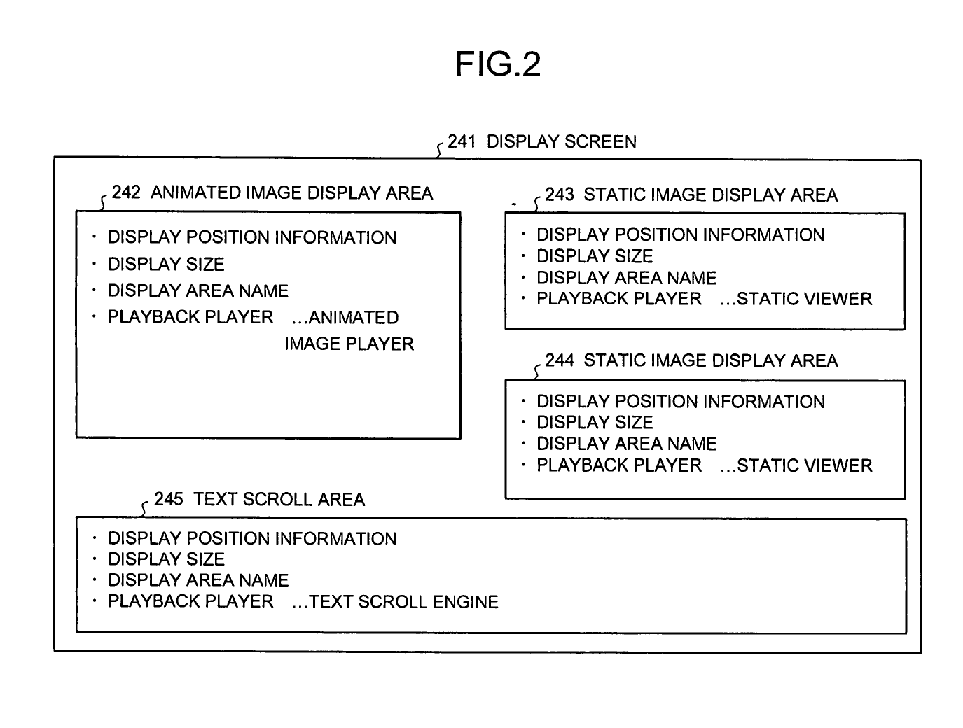

An example of the present invention is explained below in reference to FIGS. 1 to 10. First, FIGS. 1 and 2 explain data and control information files that are handled by the information distribution display system according to the example of the present invention.

FIG. 1 presents a structure of a presentation package 2 that is the largest unit of all the files handled by the information distribution display system of the example of the present invention. As shown in FIG. 1, the presentation package 2 is composed of a package information file 21, a menu file 22, an automatic presentation script 23, a plurality of presentation files 24-1 to 24-n, a plurality of material data 25-1 to 25-m, and a plurality of template files for playback 26-1 to 26-k. The package information file 21, the menu file 22, the automatic presentation script 23, the presentation files 24-1 to 24-n, and the template files for playback 26-1 to 26-k are typically control information files in which information used for display of programs composed of a plurality of material data (contents) is defined, and the material data (contents) 25-1 to 25-m are real display data displayed by the action of the above control information files.

The material data 25-1 to 25-m are content data used in the template files for playback 26-1 to 26-k. The material data 25-1 to 25-m include, for example, animated image files, static image files, voice files, and voice animation image files. The animated image files may use an MPEG (Moving Picture Experts Group) format or animation GIF (Graphic Interchange Format). Static image files may use a JPEG (Joint Photographic Coding Experts Group) format, PNG (Portable Network Graphics) format, GIF (Graphic Interchange Format), or TIFF (Tagged Image File Format). Voice files may use a MIDI (Musical Instruments Digital Interface) format, MP3 (MPEG Audio Layer-3) format, or WMA (Windows (R) Media Audio) format. Voice animation image files may include information of voices and animated images such as Flash format, text files, and the like.

The template files for playback 26-1 to 26-k define display position information that shows display positions of one to a plurality of display areas (window) to display each material data, display sizes of the display areas, a playback player (linkage of a display area with a playback player) that is used for playback of the material data displayed in the corresponding display areas, and the like.

For example, as shown in FIG. 2, one program, which includes four areas of an animated image display area 242 that displays an MPEG format file, a static image display area 243 that displays a JPEG format file, a static image display area 244 that displays a PNG format file, and a text scroll area 245 that displays a text file, is assumed to be displayed on a display screen 241.

In this case, the template file for playback defines, with respect to the animated image display area 242, display position information of a display area name that shows the animated image display area 242, its display size, and information linking the display area name that shows the animated image display area 242 with a playback player (in this case, a certain animated image player).

With respect to the static image display area 243, the template file for playback defines display position information of a display area name that shows the static image display area 243, its display size, and information linking the display area name that shows the static image display area 243 with a playback player (in this case, a certain static viewer).

With respect to the static image display area 244, the template file for playback defines display position information of a display area name that shows the static image display area 244, its display size, and information linking the display area name that shows the static image display area 244 with a playback player (in this case, a certain static viewer).

Finally, with respect to the text scroll area 245, the template file for playback defines display position information of a display area name that shows the text scroll area 245, its display size, and information linking the display area name that shows the text scroll area 245 with a playback player (in this case, a certain text scroll engine).

As describe above, a display position and a display size of each display area and information linking each display area with each playback player are defined in the template file for playback. With the use of these definitions in the template file for playback, a layout of the display screen 241 can be easily changed. In other words, a plurality of template files for playback having different definitions are prepared in advance. As a result, it is possible to create different programs simply by changing a display layout of a template file for playback or by changing material data to be displayed in each display area of the same template file for playback.

Each of the presentation files (program file) 24-1 to 24-n defines one of the file names of the template files for playback 26-1 to 26-k and the information linking one or more of the described display areas (display area name) defined in the corresponding template file for playback with one or more of material data 25-1 to 25-m (file name). For example, in FIG. 2, when the material data 25-1 is displayed in the animated image display area 242, the material data 25-2 is displayed in the static image display area 243, the material data 25-3 is displayed in the static image display area 244, and the material data 25-4 is displayed in the text scroll area 245, the linking information prescribed for such linkage can be defined in one certain presentation file 24-1. As is described, one presentation file corresponds to one program, and each of the presentation files 24-1 to 24-n is used for file management of the material data 25-1 to 25-m and the template files for playback 26-1 to 26-k.

The menu file 22 defines the information defining the menu screen including the auto playback buttons with which an information viewer selects one program from a plurality of programs (corresponding to the plurality of presentation files 24-1 to 24-n), and defines the information linking the auto playback buttons (auto playback button names) with the file names of presentation files.

The automatic presentation script 23 defines information prescribing a display starting time and a display ending time of each program, i.e., information associated with each display schedule of each program. In other words, one presentation file name is defined corresponding to one display starting time and one display ending time.

The package information file 21 defines each file name of the menu file 22 and the automatic presentation script 23. The package information file 21 is used for file management of these files 22 and 23. The menu file 22 and the automatic presentation script 23 manage the presentation files 24-1 to 24-n.

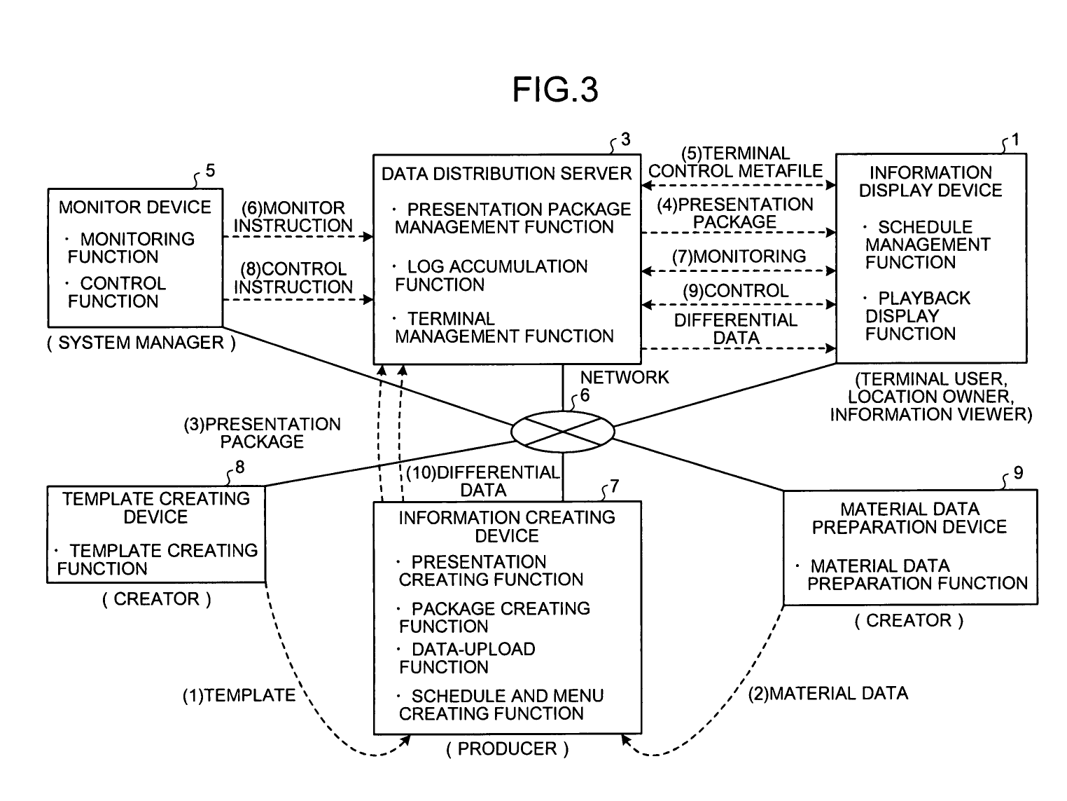

FIG. 3 presents a system structure of the information distribution display system according to the example of the present invention. As shown in FIG. 3, the information distribution display system according to the example of the present invention is structured by communicably connecting a material data preparation device 9, a template creating device 8, an information creating device 7, a data distribution server 3, a monitor device 5, and an information display device 1 to one another through a network 6 such as the Internet.

The material data preparation device 9 is a machine such as a personal computer used by a creator to prepare the material data 25-1 to 25-m. The material data preparation device 9 is provided with a material data preparation function that prepares material data such as an animated image file, a static image file, a text file, and a voice animation image file.

The template creating device 8 is a machine such as a personal computer used by a creator to create the template files for playback 26-1 to 26-k. The template creating device 8 is provided with a template for playback creating function that creates template files for playback.

The information creating device 7 is a machine such as a personal computer used by a producer to create programs. The information creating device 7 creates all files included in the presentation package 2, as shown in FIG. 1, with the use of various material data prepared by the material data preparation device 9 and the template files for playback created by the template creating device 8. The created presentation package is transmitted to the data distribution server 3 through the network 6. The information creating device 7 is provided with a presentation creating function, a schedule and menu creating function, a package creating function, and data-upload function.

The presentation creating function is a function with which a producer creates a plurality of presentation files 24-1 to 24-n corresponding to a plurality of programs with the use of various material data 25-1 to 25-m prepared by the material data preparation device 9 and the template files for playback 26-1 to 26-k created by the template creating device 8. Specifically, as described above, the producer defines a file name of one template file for playback for every presentation file as well as the linkage of one or more of the described display areas (display area name) defined in one corresponding template file for playback with one or more of the material data 25-1 to 25-m (file names). In addition, the presentation creating function is provided with a function that plays back the material data with the use of the template files for playback defined in the presentation files to confirm the presentation files created by the producer and is provided with a function that displays the programs The schedule and menu creating function is a function that determines a display schedule of the programs defined in each presentation file created by the presentation creating function based on the priority information that shows the priority order of the display order among the respective presentation files designated by the producer, and that creates the automatic presentation script 23 and the menu file 22.

The package creating function is a function to select the predetermined menu file 22, the automatic presentation script 23 or the presentation files 24-1 to 24-m and to create a package information file 21 or change the files contained in the package information file 21 when the menu file 22, the automatic presentation script 23 or the presentation files 24-1 to 24-n are created or changed.

The data-upload function is a function that transmits the presentation package 2 created by the package creating function to the data distribution server 3 through the network 6. In this case, the data-upload function creates a plurality of packages so that one or more files selected from a plurality of files contained in the presentation package 2 are contained in one package. Then, each of the created packages is encrypted and attached with package recognition information to transmit to the data distribution server 3 by the data-upload function. The package recognition information includes a presentation package name to which the package itself belongs, information that shows contents of the respective files contained in the package itself (for example, the files are composed of new material data 25-1 to 25-6, changed or updated data of the material data 25-1 to 25-8, or composed of new presentation files 24-1 to 24-10 and the menu file 22), and the like. In this case, the package corresponds to a group of files that is encrypted with the same key to be transmitted.

When a package is created, the data-upload function judges whether the subject presentation package 2 is new or updated. When the presentation package is updated, a package containing only the updated files is created and transmitted by the data-upload function. This packaging intends to reduce the amount of data communicated. When the data amount is small, the data-upload function may encrypt the presentation package 2 itself and transmit it.

The data distribution server 3 monitors and controls the information display device 1 based on monitor instructions and control instructions of the monitor device 5. The data distribution server 3 is provided with a presentation package management function, a terminal management function, and a log accumulation function.

The presentation package management function not only stores packages received from the information creating device 7, but also judges from the package recognition information whether the received package is a single package composing a new presentation package 2 or a package containing only updated files in the already-stored presentation package 2. When the package contains only updated files, the presentation package management function decodes the package stored therein and the package received from the information creating device 7, and only the updated portion (files in the package received from the information creating device 7) within the stored presentation package is changed, packed, encrypted, and stored by the presentation package management function. Moreover, when the package is one package composing a new presentation package 2, the presentation package management function receives all packages of the new presentation package 2, packs all the packages in a presentation pack, and then stores it.

The terminal management function transmits a transmission request for load information of a central processing unit (CPU) in the information display device 1 and information showing various conditions in the information display device 1, such as temperature of the displaying unit of the information display device 1 (hereinafter, referred to as monitoring information), to the information display device 1 based on monitor instructions from the monitor device 5 when accessed by polling from the information display device 1. Moreover, when accessed by polling from the information display device 1, the terminal management function transmits a download request for a presentation package or package to the information display device 1, transmits a switching instruction for a presentation package in a plurality of presentation packs that have already been stored in the information display device 1 to the information display device 1, and transmits a setting instruction for polling an interval change to the information display device 1 based on the control instructions from the monitor device 5.

The log accumulation function is a function to accumulate and store monitoring information transmitted from the information display device 1. Various data stored by the log accumulation function can be browsed from the monitor device 5.

The information display device 1 is a device for displaying the programs created by the information creating device 7. The information display device 1 is provided with a schedule management function and a playback display function and stores one or more presentation packs, which are encrypted packages or presentation packs downloaded from the data distribution server 3.

The schedule management function is used for management of a display schedule of programs based on the automatic presentation script 23 in the presentation package 2 and outputs a playback instruction that initiates playback of programs and a stop instruction that halts playback of the programs to the playback display function. The playback instruction is output when it is a program starting time that is defined in the automatic presentation script 23 or when an information viewer presses a certain program selection button on the menu screen to select a program. The playback instruction includes the file name of the presentation file corresponding to the program to be played back. The stop instruction is output when the time reaches a display ending time designated by the automatic presentation script 23 during displaying a program or when an information viewer selects a program different from the one in the middle of its playback on the menu screen.

Further, the schedule management function is also provided with a function that switches presentation packs within a plurality of presentation packs that have already been stored based on the control instruction transmitted from the monitor device 5 through the data distribution server 3.

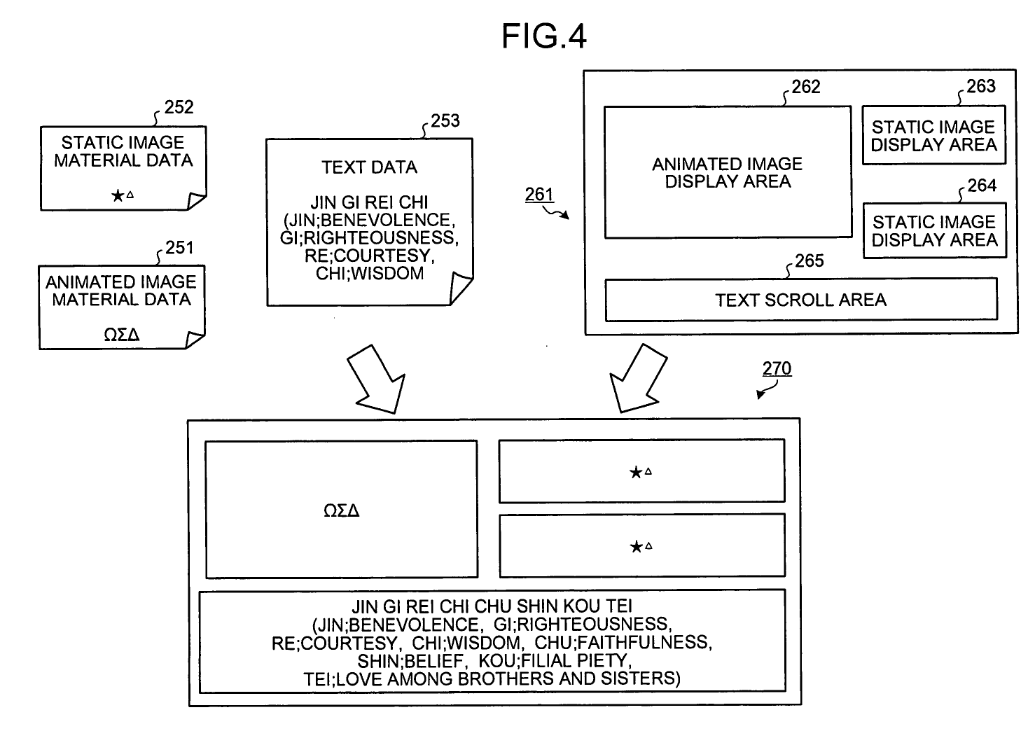

The playback display function is a function that displays programs based on the presentation files contained in a playback instruction. The playback display function plays back one or more material data linked with one or more display areas of the template files for playback that are defined in the presentation files with the use of each playback player in a corresponding display area and displays programs. For example, as shown in FIG. 4, assuming that a program is displayed by a template file for playback 261 that defines an animated image display area 262, static image display areas 263 and 264, a text scroll area 265, animated image material data 251 linked with the animated image display area 262, static image material data 252 linked with the static image display areas 263 and 264, and text data 253 linked with the text scroll area 265, the animated image material data 251 are played back in the animated image display area 262, the static image material data 252 are played back in the static image display areas 263 and 264, and the text data 253 are played back in the text scroll area 265 by their respective playback players to display a program 270. When a template file for playback is not defined in a presentation file, the playback display function displays a program with the use of a default template file for playback that is stored in advance.

The monitor device 5 is a machine such as a personal computer on which a system manager monitors and controls the information display device 1 and is provided with a monitoring function and a control function. The monitoring function is a function that transmits a monitor instruction to retrieve monitoring information from the information display device 1 to the data distribution server 3. The control function is a function that transmits to the data distribution server 3 control instructions to control the information display device 1 such as a download request for a presentation package or a package, a switching instruction of presentation packs, and a setting instruction for polling interval change.

Although one each of the template creating device 8, the material data preparation device 9 and the information display device 1 is provided in the information distribution display system shown in FIG. 3, the information distribution display system may be provided with one or more of each of these devices.

Next, an action outline of the information distribution display system according to the example of the present invention is explained. First, an action to display a program on the information display device 1 is explained. The template creating device 8 transmits the template files for playback 26-1 to 26-k created by a creator, and the material data preparation device 9 transmits the material data 25-1 to 25-m prepared by a creator to the information creating device 7.

The information creating device 7 creates files that are contained in the presentation package 2 shown in FIG. 1 with the use of the various material data 25-1 to 25-m prepared by the material data preparation device 9 and the template files for playback 26-1 to 26-k created by the template creating device 8. The information display device 7 also encrypts the presentation package 2 or the package that has been created by the package creating function to transmit it to the data distribution server 3 through the network 6.

The data distribution server 3 decodes the received presentation package 2 or package and then encrypts it for storage. The data distribution sever 3 allows downloading of the presentation package 2 or the package stored therein to the information display device 1 based on the control instructions from the monitor device 5.

The information display device 1 decodes the presentation package 2 or the package downloaded from the data distribution server 3, and plays back various material data to display programs with the use of the template files for display defined in the presentation files of the programs to be displayed based on the automatic presentation script 23 or the menu file 22 in the presentation package 2.

Next, an action to monitor the information display device 1 from the monitor device 5 is explained. The information display device 1 accesses the data distribution server 3 by polling at predetermined time intervals. When the data distribution server 3 is accessed by the information display device 1 and the monitor device 5 sends an instruction, the data distribution server 3 transmits a request for transmission of monitoring information to the information display device 1. The information display device 1 transmits monitoring information based on the request for transmission of monitoring information to the data distribution server 3. The data distribution server 3 resets the monitor instruction (a state of no monitor instruction present) from the monitor device 5 after storing the received monitoring information. In this way, the monitor device 5 makes an access to the data distribution server 3 with arbitrary timing and browses the monitoring information stored in the data distribution server 3 to monitor the conditions of the information display device 1.

Next, an action to control the information display device 1 from the monitor device 5 is explained. The information display device 1 accesses the data distribution server 3 by polling with predetermined timing. When the data distribution server 3 is accessed by the information display device 1 and the monitor device 5 sends a control instruction, the data distribution server 3 transmits the control instruction to the information display device 1. The information display device 1 carries out control based on the received control instruction.

When the control instruction is an instruction to download a presentation package 2 or a package, the information display device 1 requests the designated presentation package or package from the data distribution server 3 by the control instruction, and downloads the designated presentation package or package. When the control instruction is an instruction to switch the presentation packs, the information display device 1 switches the presentation packs from the currently used package to the designated presentation package using the schedule management function. Moreover, when the control instruction is an instruction to set the polling intervals, the information display device 1 sets the polling intervals so as to access the data distribution server 3 at the intervals designated by the control instruction.

In a case where a GET method of HTTP (Hypertext Transfer Protocol) is used as a communication protocol between the data distribution server 3 and the information display device 1 by polling, communication is carried out using a metafile. In other words, the GET method of HTTP is used to access the data distribution server 3 from the information display device 1 at the predetermined polling intervals. At this time, terminal identification data (ID) (ID for every information display device 1) are attached. A terminal control metafile is sent from the data distribution server 3. The terminal control metafile includes an instruction file that allows control such as switching of the presentation packs. When a monitor instruction is sent from the data distribution server 3 by the terminal control metafile, monitoring items are sent to the data distribution server 3 as a terminal information metafile. When an instruction that commands to receive a terminal remote control metafile by the terminal control metafile is sent from the data distribution server 3, the information display device 1 accesses the data distribution server 3 to receive the terminal remote control metafile by the GET method of HTTP and to receive the terminal remote control metafile from the data distribution server 3. The information display device 1 is controlled based on the terminal remote control metafile. The polling intervals can be changed by the terminal remote control metafile from the data distribution server 3.

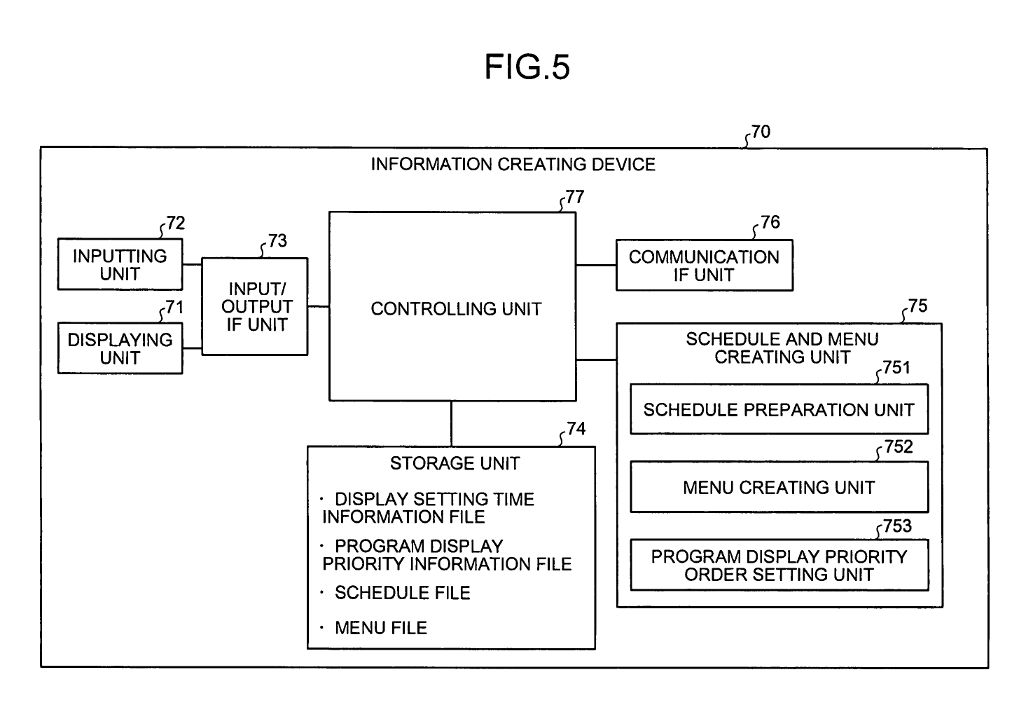

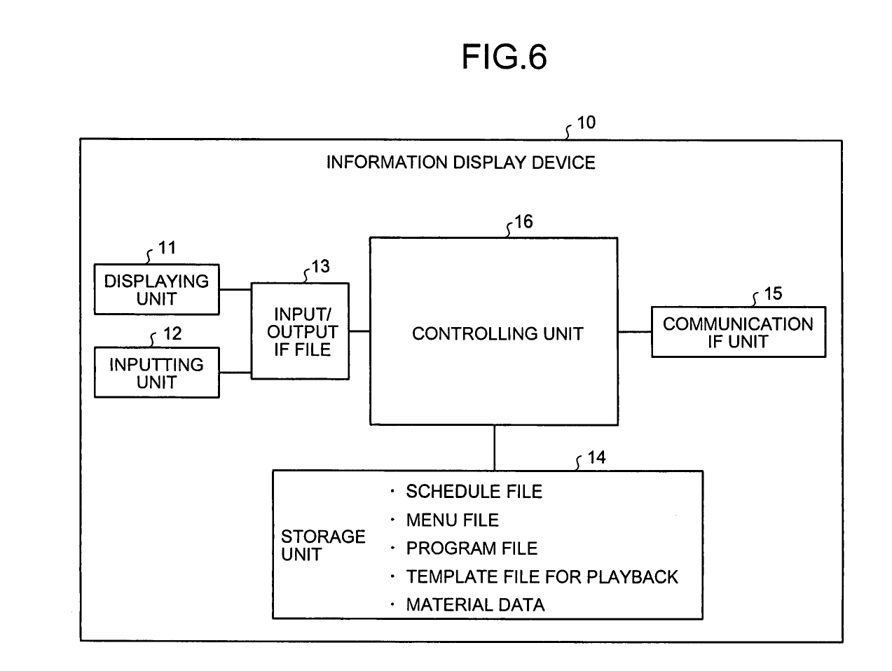

Next, the information creating device and the information display device are explained in detail as the principal part of the present invention that are applied to the above information distribution system. FIG. 5 is a block diagram presenting a structure of the information creating device. An information creating device (control information file creating device) 70 is applied to, for example, the information creating device 7 of the information distribution display system described above. Further, FIG. 6 is a block diagram presenting a structure of the information display device. An information display device 10 is applied to, for example, the information display device 1 of the above information distribution display system.

As shown in FIG. 5, the information creating device 70 according to the present example is composed of a displaying unit 71, an inputting unit 72, an input/output IF (intermediate frequency) unit 73, a storage unit 74, a schedule and menu creating unit 75, a communication IF (intermediate frequency) unit 76, and a controlling unit 77.

The information creating device 70 is a device that prepares a schedule for program playback and a menu for program selection at the time of playback (display) of a plurality of programs (information for display) as control information files such as the schedule file (automatic presentation script) 23 and the menu file 22. One program corresponds with one presentation file (program file) as described earlier, and when a program file is determined, a template file for display and material data to be used are determined as described above. “Schedule” according to the present example means the date, time, etc., on which programs are allowed to be played back. The order of playback of programs is prescribed for every program and serves a function of program schedule for program playback. At the time of creating a schedule file, it is possible to set a playback starting time and a playback ending time for every program and create a schedule file. Alternatively, it is also possible to set an order of programs to be played back and create a schedule file. In the schedule file, one program file name is defined by linking with one playback starting time and playback ending time. Alternatively, each program file name may be defined by linking with its playback starting order.

“Menu” according to the present example means that automatic playback buttons to play back each program automatically are arranged on the screen and serves as a function that shows a list for program selection. Further, one or more automatic playback buttons are arranged for every program on the menu screen. The menu file defines information linking the automatic playback buttons (button name for automatic playback) with the program file names. When a program is displayed using a menu, designation of an automatic playback button with a mouse, for example, makes it possible to display a desired program.

At least part of a plurality of program files to be used for menu playback and part of a plurality of program files to be used for schedule playback are shared mutually between them. Sharing the program files makes program display possible. In other words, when there is one program file to be shared, both schedule playback and menu playback can be carried out.

For example, a menu file to playback program files A, B, and C, and a schedule file to playback the programs A, B, and C are created from the three program files A, B, and C. Each program file A, B, or C can be played back from both the menu and the schedule. To the menu file and the schedule file, information (identification data) showing that the files are for playback of the programs A, B, and C may be attached for file management. Thus, the information display device 10 can carry out schedule playback and menu playback of a plurality of programs with the use of a plurality of program files, the schedule file for the programs, and the menu file for the programs.

The displaying unit 71 is a device that displays contents of the schedule file and the menu file for confirmation and may be provided with a liquid crystal display panel, a plasma display device, and the like.

The inputting unit 72 is a device to input various information and may be provided with a mouse and a keyboard. To the inputting unit 72, for example, information on playback (display) priority of programs (hereinafter, referred to as program display priority information) and information on display setting time of programs (hereinafter, referred to as display setting time information) is input as a program display priority information file and a display setting time file.

Further, at the time of creating a schedule file and a menu file, instruction information and selection information on setting a change of the determination method of display priority order of the programs based on the program display priority information, designation of program names, and the like. Further, instruction information on transmission of the created schedule file and menu file are input to the inputting unit 72. In the instruction information and the selection information are included file names of program files (presentation file) corresponding to the programs to be designated.

The program display priority information means information on priority at the time of playback of each program. The schedule and menu creating unit 75 creates a menu file and a schedule file so that a program having a high-priority can be preferentially played back. For example, in a case where playback setting times of a plurality of programs overlap one another at the time of creating a schedule file, the schedule file is created such that the program having a high-priority is preferentially played back. The display setting time information means information of times when the programs are desired to be played back that are set in advance for every program file. For example, a time is prescribed from 7:00 in the morning until 9:00 in the evening.

Moreover, a menu is created so that the name of program with a high-priority is displayed on the automatic playback button that is preferably arranged at a conspicuous position in the menu. The menu file of the menu and the schedule file of the schedule created based on the program display priority information may be attached with information (identification data) on what program display priority information is the basis of creating these files. One program display priority information file containing the program display priority information may be prepared for every program, and a plurality of programs may be gathered in one to construct a program display priority information file.

The input/output IF unit 73 is an interface to execute data input from the inputting unit 72. The storage unit 74 is configured to store data input from the inputting unit 72, the control information file created by the schedule and menu creating unit 75, and the like. For example, the program display priority information file and the display setting time file for every program input from the inputting unit 72, the schedule file and the menu file created by the schedule and menu creating unit 75, and the like are stored.

The schedule and menu creating unit 75 is provided with a schedule preparation unit 751, a menu creating unit 752, and a program display priority order setting unit 753. The program display priority order setting unit 753 determines the display priority order of the programs from the program display priority information stored in the storage unit 74 when creating the menu file and the schedule file.

The schedule preparation unit 751 automatically prepares a schedule for a plurality of programs as a schedule file based on the display setting time information file and the display priority order for every program that is determined by the program display priority order setting unit 753. The schedule files may also be manually prepared. The schedule file prepared by the schedule preparation unit 751 is stored in the storage 74.

The menu creating unit 752 automatically creates a menu for a plurality of programs as a menu file based on the display setting time information file and the display priority order for every program that is determined by the program display priority order setting unit 753. The menu file is composed of information on a display position and a display size of the automatic playback button for every program, a playback screen for preview of programs, and the like. The menu file may be manually created.

Further, when the menu file is created, a template for menu creation (hereinafter, referred to as template file for menu) may be used. The template file for menu is a control information file in which information required to display a plurality of programs on the menu screen is defined. The menu created by the menu creating unit 752 is stored in the storage 74.

In this way, the schedule preparation unit 751 and the menu creating unit 752 designate program file names without the program files themselves. Owing to the designation, the schedule preparation unit 751 and the menu creating unit 752 can create a schedule file and a menu file once playback setting time information and program display priority information is determined for every program.

Further, a schedule file and a menu file are created only with the playback setting time information and the program display priority information. Therefore, automatic preparation of a schedule by the schedule preparation unit 751 and automatic creation of a menu by the menu creating unit 752 can be carried out at the same time. Designation of the program files, the playback setting time information file, and the program display priority information file that are used to create the schedule file and the menu file and setting changes of the program display priority information are carried out from the inputting unit 72.

The communication IF unit 76 is an interface that receives the program files and the template file for menu from the template creating device 8, the material data preparation device 9, and the like through the network 6, and transmits the schedule file, the menu file, and the like created by the schedule and menu creating unit 75 to the information display unit 10.

When a menu file and a schedule file are sent, only the menu file and the schedule file may be transmitted. Further, the menu file and the schedule file may be packed together with program files, template files for playback, and material data and transmitted as a presentation file.

When only the menu file, the schedule file, and the template file for menu are transmitted, menu playback and schedule playback are carried out with the use of the program files stored in advance in the information display device 10 that are receiving ends of these files. When the information display device 10 that are receiving ends of these files do not store the program files in advance, it is possible to carry out menu playback and schedule playback after the information display device 10 retrieve the program files, the template files for playback and the material data that are used for menu playback and schedule playback.

To the menu file and the schedule file are attached the information (file name) to identify these files. When the communication IF unit 76 transmits the menu file and the schedule file to the information display device 10, the menu file and the schedule file are retrieved from the storage unit 74 based on the instruction information and the selection information for file transmission input from the inputting unit 72. The retrieved files are transmitted from the communication IF unit 76 to the file receiving end based on the information input from the inputting unit 72, such as address of the file receiving end in the information display device 10.

When a menu file and a schedule file are updated, only the menu file and the schedule file to be updated may be transmitted from the information creating device 70 to the information display device 10. In addition, when programs are updated, the program files, and if necessary, the template files for playback and the material data, may be sent from the information creating device 70 to the information display device 10.

The controlling unit 77 controls the displaying unit 71, the input/output IF unit 73, the storage unit 74, the communication IF unit 76, and the schedule and menu creating unit 75. When the program display priority information is input from the inputting unit 72, the controlling unit 77 allows the storage unit 74 to store it. When the communication IF unit 74 receives the program files and the template file for menu, the controlling unit 77 causes the storage unit 74 to store them.

When instruction information, which is information relating to changes in settings on how to determine a display priority order, and the selection information is input from the inputting unit 72, the controlling unit 77 allows the storage unit 74 to rewrite the program display priority information file stored in the storage unit 74 and the program display priority order setting unit 753 to change the settings of the priority order in the program display priority order setting unit 753. In a case where a menu file and a schedule file are created and when instruction information and selection information on designation of programs and the like is input from the inputting unit 72, the controlling unit 77 allows the storage unit 74 to send the program display priority information file of the program corresponding to this instruction information and selection information to the program display priority order setting unit 753.

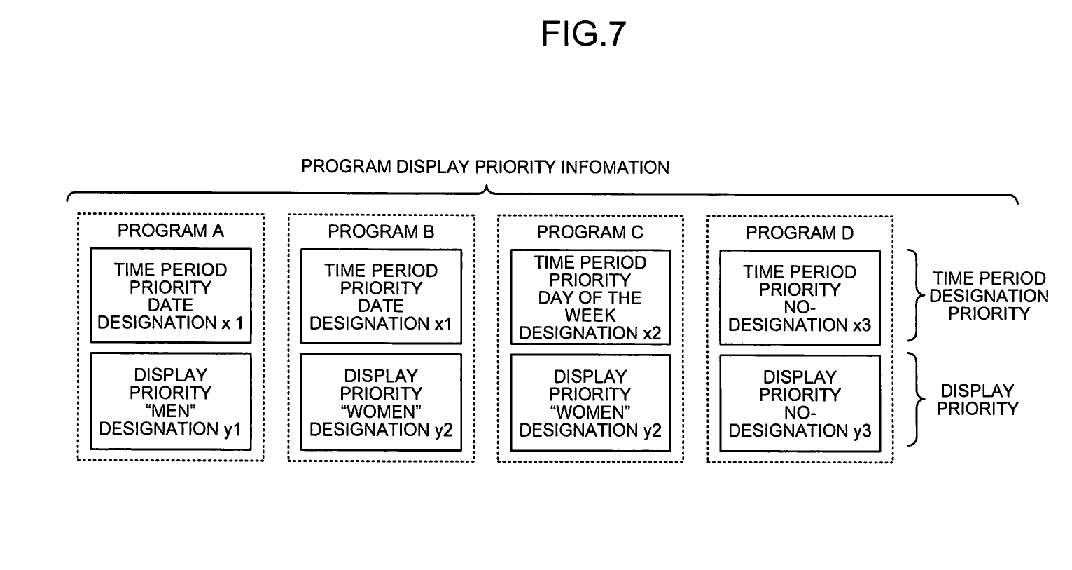

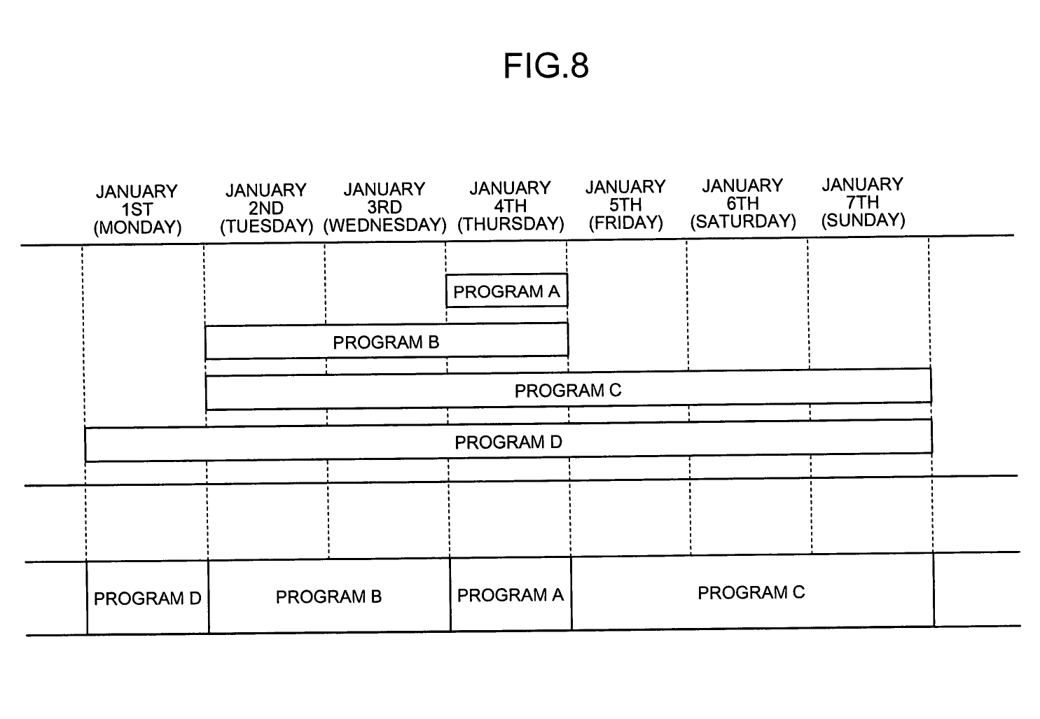

Next, a preparation method for a schedule based on the program display priority information is explained according to FIGS. 7 and 8. The schedule is prepared by setting a date and a time of program playback for every program. The program display priority information includes one to a plurality of priorities for every program. When a plurality of priorities are included, which priority is preferentially adopted is set in advance. In addition, for example, a daily display starting time and display ending time for each program are set in advance.

FIG. 7 is an explanatory drawing of the contents of the program display priority order information. FIG. 7 presents a case in which the program display priority information includes time period priorities and display priorities. For example, the setting is carried out such that the time period priorities are preferentially adapted to the display priorities.

The time period priority means priority based on the designation of time period in which a program is played back. For example, the priorities are expressed by a date designation x1, a day of the week designation x2, a no-designation x3, and the like. The date designation x1 designates a date on which a program is played back, the day of the week designation x2 designates a day of the week on which a program is played back, and the no-designation x3 has no time period designation for program playback.

The display priority means priority based on the contents of programs when the display setting times of the programs overlap one another. For example, the display priorities are expressed by a “men” designation y1, a “women” designation y2, and a no-designation y3. Programs of the “men” designation y1 are for men, and the designation is set when the programs are played back at a place where there are more men. Programs of the “women” designation y2 are for women, and the designation is set when the programs are played back at a place where there are more women. The no-designation y3 represents no designation for a place to play back programs.

In various priorities, which designation is given a high-priority is set in advance. The time period priority is composed of the date designation x1, the day of the week designation x2, and the no-designation x3. Therefore, for example, the programs to be played back having a high-priority are set in advance in the order of descending priorities such as the order of the date designation x1, the day of the week designation x2, and the no-designation x3. In addition, the display priority is composed of the “men” designation y1, the “women” designation y2, and the no-designation y3 here. Therefore, for example, the programs to be played back are set in advance in the order of descending priorities such as the order of the “men” designation y1, the “women” designation y2, and the no-designation y3.

In a case where a schedule is prepared based on such settings, and when, for example, the display setting times of a program having a time period priority of the date designation x1 and a program having a time period priority of the day of the week designation x2 overlap each other, the scheduled is prepared such that the program having a time period priority of the date designation x1 is preferentially incorporated into the schedule. Similarly, in a case where a schedule is prepared, and when, for example, the display setting times of a program having a display priority of the “men” designation y1 and a program having a display priority of the “women” designation y2 overlap each other, the schedule is prepared such that the program having a display priority of the “men” designation y1 is preferentially incorporated into the schedule.

In a case of preparation of a schedule, and when the display setting times of programs overlap each other, the schedule is prepared based on the time period priorities of the programs. When the display setting times for the programs having the same time period priority overlap each other, the schedule is prepared based on the order of the display priority.

An automatic preparation method for a schedule will be explained in a case where a program A has a date designation x1 and a “men” designation y1, a program B has a date designation x1 and a “women” designation y2, a program C has a day of the week designation x2 and a ‘women’ designation y2, and a program D has a no-designation x3 and a no-designation y3.

FIG. 8 is an explanatory drawing of a creation method for a schedule file for the programs A to D. When the display setting times of the programs A to D overlap one another, an adjustment is made to compensate for this overlap. A preparation method of the schedule is explained in a case where the display setting times of the programs A to D overlap one another.

First, the program display priority order setting unit 753 gives priority order of playback to the programs A to D with respect to their respective time period priorities. Here, the program A and the program B have a date designation x1 with a higher-priority, respectively, and the program C has a day of the week designation x2 with a following high-priority. Accordingly, the priority order for playback is determined that the programs A and B come first, followed by the program C and by the program D in that order.

At this stage, the priority ranks of the programs A and B are the same. Therefore, the priority for playback is sought to rank the programs A and B based on the display priority. Here, the program A has the “men” designation y1 with a higher-priority and the program B has the “women” designation y2 with a following high-priority. Thus, the priority order for playback is determined that the program A comes first, and the program B comes next. From the foregoing result, the priority for playback is ranked such that the program A comes first, followed by the program B, the program C, and the program D in that order.

The schedule preparation unit 751 preferentially places the programs A to D in the schedule in the order of the program A, the program B, the program C, and the program D according to the order of their priority ranks based on the display priorities determined by the program display priority order setting unit 753. Therefore, on preparation of the schedule, the program A is first placed in the schedule, the program B is next placed in a vacant portion, the program C is placed in another vacant portion, and the program D is placed last. When the display setting times of the programs A to D do not overlap one another, the programs A to D are placed in the schedule as they are.

A case of a schedule from January 1st (Monday) to January 7th (Sunday) provides an example for a schedule preparation. For example, when the date designation x1 for the program A is January 4th (Thursday), and the date designations x1 for the program B are January 2nd (Tuesday), 3rd (Wednesday), and 4th (Thursday), the program A is first placed on January 4th (Thursday) in the schedule. Then, the program B is placed on January 2nd (Tuesday) and 3rd (Wednesday) in a vacant portion of the schedule.

Further, when, for example, the day of the week designations for the program C are from Monday to Friday and Sunday, the program C is placed on January 5th (Friday) to January 7th (Sunday) that are in a vacant portion of the schedule, respectively, and the program D is placed in the remaining vacant portion of the schedule. Which priority is preferentially adopted and which designation is given a higher-priority can be set in an arbitrary way. In the present example, there are programs with the no-designation x3 and the no-designation y3, which fills the time vacancy in the schedule.

User group of programs, arrangement positions for the information display device 10, time periods for playback of the programs, and information on the contents of the programs may be input as the program display priority information. Information on the content of the programs includes, for example, a piece of information on kinds of material such as animated image and static image and a piece of information on sound effect in the programs.

A schedule may be prepared by setting programs depending on not only the program starting dates and times and the program ending dates and times, but also the order of playback and the number of repetition of the programs. For example, a schedule to play back the programs for predetermined time periods in the order of the program A, the program B, the program C, and the program D may be prepared. Further, it is acceptable to set to play back many times a program having a higher-priority. For example, after the program A having a higher-priority is played back five times, the programs B, C, and D are played back once, respectively. Furthermore, a time may be allocated to every program.

For example, a schedule is prepared such that the program A is played back from one o'clock to three o'clock, the program B is played back from three o'clock to five o'clock, the program C is played back from five o'clock to seven o'clock, and the program D is played back from seven o'clock to nine o'clock. Further, each program is repeatedly played back (repetition) during the allocated time period, respectively. Programs with a high-priority may be played back during a much-watched time period.

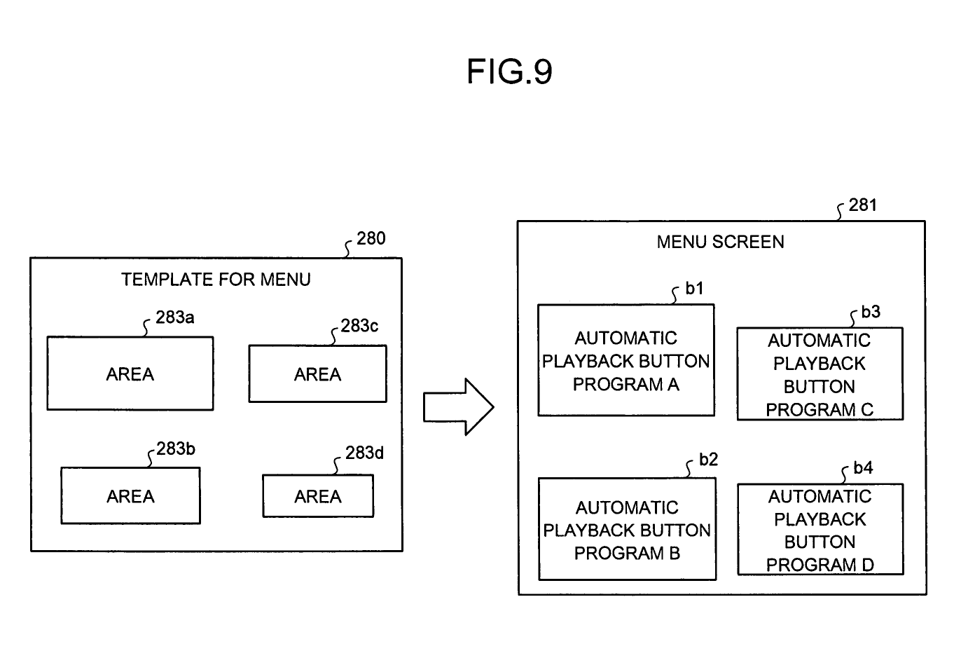

Next, a creation method for a menu file based on the program display priority information is explained according to FIG. 9. A case is explained where a menu is created based on a menu template file for menu.

First, the files used to create the menu file preferably include the program display priority information file; the material data for automatic playback button (on a menu screen 281 of FIG. 9, the material data represent automatic playback buttons b1 to b4); the template file for menu to display the material data for automatic playback button; the information linking the material data for automatic playback button (material data names) with the program files (program file names); and the information on arrangement priority of a plurality of display areas defined in the template file for menu.

The menu file that is created with the use of the above files includes the material data for the automatic playback button (on the menu screen 281 of FIG. 9, the material data represent the automatic playback buttons b1 to b4); the template file for menu to display the material data for automatic display button; the information linking the material data for automatic playback button (material data names) with the program files (program file names); and, besides the preceding files prepared in advance, the information linking the material data for automatic playback button (material data names) with the display areas (display area names) defined in the template file for menu.

The aim for the creation of the menu file based on the program display priority information is to determine a linkage of the material data for automatic playback button (material data names) with the display areas (display area names) defined in the template file for menu based on the program display priority information.

In the template file for menu, similarly to the template files for playback 26-1 to 26-k, for example, display position information that shows display positions of one or more display areas 283a to 283d to display the material data for the automatic playback buttons b1 to b4 on the menu screen 281 and the display sizes of the display areas 283a to 283d are defined, as shown in FIG. 9.

The template file for menu defines the display position, the display size, and the like of each of the display areas. Therefore, the layout of the menu screen 281 can easily be changed by changing the definition of the template file for menu. In other words, having a plurality of template files for menu with different definitions makes it possible to create a different menu screen simply by changing the display layout depending on the template file for menu to be used and the material data for automatic playback button to be displayed in each of the display areas with the use of the same template file for menu.

Hereinafter, the creation method for a menu file is specifically explained. For example, assume that the program display priority order of the program files A to D determined by the program display priority order setting unit 753 has been the order of the program file A, the program file B, the program file C, and the program file D from a higher rank to a lower rank. Further, assume that the arrangement priority of the four display areas 283a to 283d in the template file for menu 280 has been set to the order of the display area 283a, 283b, 283c, and 283d from a higher rank to a lower rank. A high arrangement priority of the display area means that, for example, the display position is at a more conspicuous position and its display area size is larger.

Furthermore, assume that the linkage of the material data for automatic playback button (material data names) b1 to b4 with the program files A to D is set as follows: the material data b1 —the program file A; the material data b2—the program file B; the material data b3—the program file C; and the material data b4—the program file D.

Based on the above two pieces of priority order information (the program display priority order and the arrangement priority of the display areas), the information linking each of the program files A to D (program file names) with each of the display areas 283a to 283d (display area names) can be retrieved. In this case, it is possible to retrieve pieces of linkage information of the program file A—the display area 283a, the program file B—the display area 283b, the program file C—the display area 283c, and the program file D—the display area 283d.

The final output, that is, the information linking the material data for automatic playback button b1 to b4 with the display areas 283a to 283d defined in the template file for menu is retrieved based on the information linking each of the program files A to D (program file names) with each of the display areas 283a to 283d (display area names) retrieved as described above, and based on the above-described information linking the material data for automatic playback button (material data names) b1 to b4 with the program files A to D retrieved in the manner describe above.

In this case, it is possible to retrieve pieces of information linking the material data for automatic playback button with the display areas in which the material data b1—the display area 283a, the material data b2—the display area 283b, the material data b3—the display area 283c, and the material data b4—the display area 283d are linked with each other, respectively.

On the menu screen 281 according to the menu file retrieved as described above, the program file A with the first display priority rank is displayed as the automatic playback button b1 at the position corresponding to the display area 283a with the highest arrangement priority. The program file B with the second display priority rank is displayed as the automatic button b2 at the position corresponding to the display area 283b with the second arrangement priority. The program file C with the third display priority rank is displayed as the automatic playback button b3 at the position corresponding to the display area 283c with the third arrangement priority. Lastly, the program file D with the fourth display priority rank is displayed as the automatic playback button b4 at the position corresponding to the display area 283d with the fourth arrangement priority.

When the display priority order of the program files is determined as described above by the program display priority order setting unit 753, the display priority order of the material data for automatic playback button corresponding to the program files is automatically determined. When the program is information such as advertisements, displaying the automatic playback button corresponding to this program file in a display area (automatic playback button) with a high arrangement priority is possible, which makes it possible to enhance the pulling power of the advertisement. The display position information that shows display positions of the display areas and the display sizes of the display areas can be arbitrarily set in the template for menu 280.

By allowing the menu file to be displayed on the screen as the menu screen 281, a function to display a list of the program file names can be realized. Menu playback of the programs becomes possible based on the linkage of the automatic playback buttons with the program files in the information display device 10.

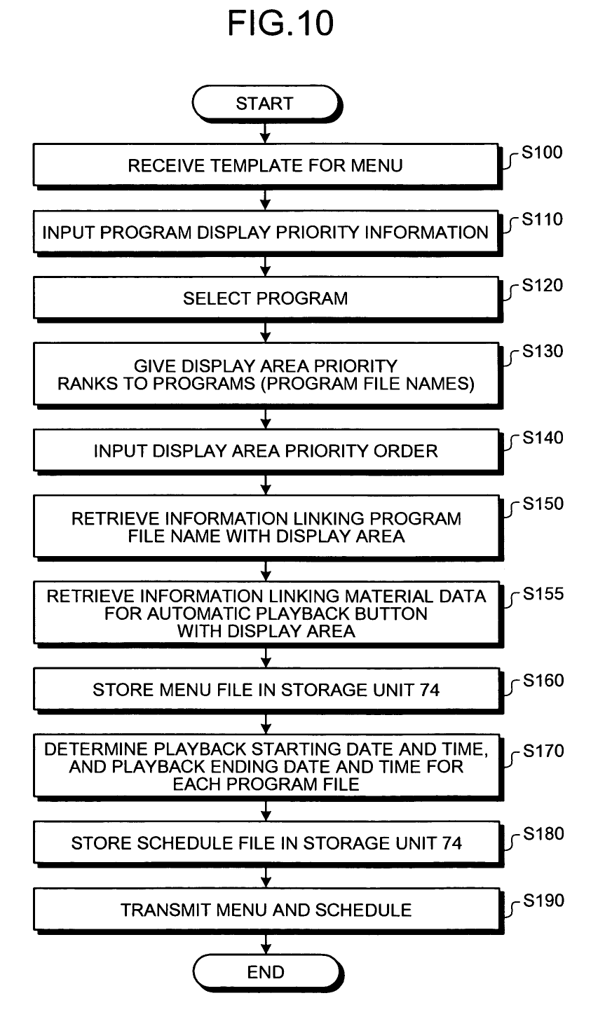

FIG. 10 is a flow chart of creation procedures for the menu file and the schedule file. The information creating device 70 receives a template file for menu from the template creating device 8 through the communication IF unit 76 (step S100), and stores the template file for menu in the storage unit 74. The program display priority information file and the display setting time information files are input from the imputing unit 72 (step S110), and these files are stored in the storage unit 74.

In the schedule and menu creating unit 75 of the information creating device 70, instruction information on which kind of priority is preferentially adopted and which kind of designation is set to be high in priority is input to the inputting unit 72 of the information creating device 70, as appropriate. Setting of the priority of the program playback in the schedule and menu creating unit 75 is changed based on the input information.

The controlling unit 77 selects a plurality of program files to create the menu file and the schedule file through the inputting unit 72 (step S120) and sends the display setting time information files and the program display priority information file of those programs from the storage unit 74 to the schedule and menu creating unit 75.

The program display priority order setting unit 753 gives display priority ranks to the programs that are included in the menu creation based on the program display priority information file (step S130). When a plurality of priorities exist, the program display priority order setting unit 753 gives a display priority rank to each program based on the setting as to which kind of priority is preferentially adopted. Moreover, when a plurality of designations of priority exist, the program display priority order setting unit 753 gives a display priority rank to each program based on the setting as to which kind of designation is given a high-priority.

To create a menu screen, the menu creating unit 752 reads out from the storage unit 74 the material data for automatic playback button, the template file for menu to display the material data for automatic playback button, the information linking the material data for automatic playback button (material data names) with the program files (program file names), and the information on the arrangement priority of a plurality of display areas defined in the template file for menu (step S140).

The menu creating unit 752 seeks the information linking each program file (program file name) with each of the display areas 283a to 283d (display area names), respectively, based on the above two pieces of priority information (the program display priority order and the arrangement priority of display areas) (step S150).

The menu creating unit 752 retrieves the final output, that is, the information linking the material data for automatic playback button with the display areas defined in the template file for menu based on the information linking each program file with each display area retrieved at step S150 and based on the information linking the material data for automatic playback button with the program files that have been read out from the storage unit 74 at step S140 (step S155).

To the storage unit 74, the menu creating unit 752 sends the menu file that includes the material data for automatic playback button, the template file for menu to display the material data for automatic playback button, the information linking the material data for automatic playback button with the program files, and the information linking the material data for automatic playback button with the display area defined in the template file for menu. The storage unit 74 stores the menu file (step S160).

On the other hand, the schedule preparation unit 751 determines a playback starting date and time, and a playback ending date and time for each program file in the schedule based on the playback setting time information file (step S170). At this time, a piece of linkage information with the program file is defined according to the playback starting date and time and the playback ending date and time for one program file. When the playback setting times of programs overlap each other, the playback starting date and time, and the playback ending date and time of each program file are determined by preferentially placing in the schedule the program file with a higher display priority rank of each program file. The playback starting date and time and the playback ending date and time of each program file are sent to the storage unit 74 as a schedule file, and the storage unit 74 stores the schedule file (step S180).

Schedule preparation by the schedule preparation unit 751 may be carried out prior to the menu creation by the menu creating unit 752. Further, the menu creation by the menu creating unit 752 and the schedule preparation by the schedule preparation unit 751 may be carried out at the same time.

The created menu file and schedule file are stored in the storage unit 74 (step S180), and these files are sent from the communication IF unit 76 to the information display device 10 (step S190) together with package information files and program files (material data, template files for playback) as a presentation package 2 as needed.

The menu file and the schedule file are not limited to being created based on the program display priority information file. A menu file may be created based on the program display priority information file, and a schedule file may be created based on this menu file. On the other hand, a schedule file may be created based on the program display priority information file, and a menu file may be created based on this schedule file. When the schedule file is created after the creation of a menu file based on the menu file, the schedule file is created by setting playback order, the number of playback repetition, and playback time periods of the programs. In a case where, after creation of a menu file in the above way, a schedule file is created based on this menu file, the program display priority order setting unit 753 gives a display priority rank to every program file based on the positions and the sizes of the display areas (automatic display buttons) on the menu screen displayed with the use of the template for menu.

When a priority rank is given to every program according to the positions and the sizes of the automatic playback buttons displayed on the menu screen, the program display priority order setting unit 753 gives high-ranks to, for example, the program file that is given to the automatic playback button positioned in the upper left of the menu screen and the program file that is allocated to a larger automatic playback button as programs with high-priorities. The schedule preparation unit 751 creates a schedule file of the programs based on the priority order for every program file. The schedule preparation unit 751 prepares a schedule such that the number of playback of a program with a high-priority is increased and the program with a high-priority is allowed to be played back in a much-watched time period.

On the other hand, when a menu file is created after creation of a schedule file based on the schedule file, the program display priority order setting unit 753 gives a priority rank to every program to be played back according to the schedule based on the playback starting date and time, the playback ending date and time, the number of playback repetition, and the total time of playback. Even in this case, the menu file creation preferably uses the material data for automatic playback button, the template file for menu, the information linking the material data for automatic playback button with the program files, and the information on the arrangement priority of a plurality of display areas defined in the template file for menu as described above. The program display priority order setting unit 753 ranks, for example, the program of which playback starting date and time and playback ending date and time are in a much-watched time period as a program file with a high display priority. Further, the program display priority order setting unit 753 ranks a program with a larger number of playback and a longer total time of playback as a program file with a high display priority. The menu creating unit 752 creates a menu file of the programs based on the display priority rank for every program file. The menu creating unit 752 determines in advance arrangement priority of the display areas based on the positions of the display areas (automatic playback buttons) and their sizes in the template for menu. Then, the menu creating unit 752 creates information linking the material data for automatic playback button with the display areas so that the program file with a high rank of the display priority corresponds with the display area with a high rank of the arrangement priority.

The program file names, information linking the program file names with the program files, the template file for menu, information on the arrangement priority of one or more of the display areas (automatic playback buttons) to display the program file names in the template for menu that are created by the template creating device 8, and the material data preparation device 9 may be received by the information creating device 70 to be stored in the storage unit 74, whereas the above items created by the information creating device 70 may be stored in the storage unit 74.

Next, the structure of the information display device 10 is explained. As shown in FIG. 6, the information display device 10 according to the present example is composed of a displaying unit 11, an inputting unit 12, an input/output IF unit 13, a storage unit 14, a communication IF unit 15, and a controlling unit 16. The controlling unit 16 is connected to the input/output IF unit 13, the storage unit 14, and the communication IF unit 15, and the input/output IF unit 13 is connected to the displaying unit 11 and the inputting unit 12. The displaying unit 11 is a device that plays back the programs according to the schedule or plays them back according to the menu, and is composed of, for example, a liquid crystal display panel, a plasma display device, and the like.

The inputting unit 12 is a device to input various information and can be composed of a mouse and a keyboard. The inputting unit 12 receives as input, requests for change of menu playback and schedule playback and instructions of programs to be played back in the menu as instruction information or selection information. The playback instruction includes the file names of the program files (presentation files) corresponding to the programs to be played back.

Input of information to the inputting unit 12 is carried out, for example, by clicking the button arranged (displayed) on the screen of the displaying unit 11 with the mouse. When input of information to the inputting unit 12 is carried out with the use of a touch panel system, the information is input by, for example, touching the button displayed on the touch panel screen of the displaying unit 11 with a finger.

For example, a switch button that switches from schedule playback to menu playback is arranged on the screen during the schedule playback. A user can make a change from schedule playback to menu playback by clicking the button with the mouse. Further, a switch button that switches from menu playback to schedule playback is arranged on the screen during the menu playback. A user may make a change from menu playback to schedule playback by clicking the button with the mouse.

When menu playback is carried out on the displaying unit 11, a user may designate the desired program by clicking with the mouse the automatic playback button corresponding to his desired program name from the menu playback screen.

After menu playback ends, the controlling unit 16 controls the switch from menu playback to schedule playback. Switching from menu playback to schedule playback may be carried out right after one program finishes or at a predetermined elapsed time after one program finishes. Further, when an information viewer (user) clicks or selects the change button with the mouse to switch to schedule playback, switching from menu playback to schedule playback may also be carried out. Furthermore, switching from menu playback to schedule playback may also be carried out by sending a control instruction to switch from menu playback to schedule playback.

The input/output IF unit 13 is an interface to output the data input from the inputting unit 72 to the displaying unit 11. The communication IF unit 15 is an interface to receive the schedule file, the menu file, the program files, and the presentation package containing these files sent from, for example, the information creating device 70.

The storage unit 14 is a storage device that stores the program files, the menu file, the schedule file, the material data, the template files for playback, and the like received by the communication IF unit 15.

The controlling unit 16 controls the above displaying unit 11, inputting unit 12, input/output IF unit 13, storage unit 14, and communication IF unit 15. In a case where the button for switching provided on the schedule screen is clicked or selected with the mouse to switch from the schedule playback screen to the menu screen, or in a case where the button for switching provided on the menu screen is clicked or selected with the mouse to switch from the menu screen to the schedule playback screen, instruction information or selection information that requests a change to menu playback or to schedule playback is sent from the inputting unit 12 to the controlling unit 16 through the input/output IF unit 13. When a change to menu playback is requested, the controlling unit 16 allows the displaying unit 11 to display a menu screen. Further, when a change to schedule playback is requested, the controlling unit 16 allows the displaying unit 11 to carry out schedule playback.

Furthermore, on the menu screen, when a desired program is selected and the automatic playback button corresponding to the program is clicked or selected with the mouse, the instruction information and the selection information for program selection is sent to the controlling unit 16 through the input/output IF unit 13, and the controlling unit 16 allows the displaying unit 11 to play back the selected program.

Next, playback procedure of a program in the information display device 10 is explained. When schedule playback is carried out, the displaying unit 11 plays back the program files stored in the storage unit 14 based on the information (e.g., playback starting time for every program) in the schedule file stored in the storage unit 14. At this time, the program may be played back with the use of the template for playback.

When instruction information to carry out menu playback is input from the inputting unit 12, the displaying unit 11 displays the menu screen stored in the storage unit 14. When a program file name on the menu screen is selected, the program file stored in the storage unit 14 is retrieved based on the selected program file name on the menu screen.

Since each automatic playback button is linked with each of the program files in the information display device 10, the menu playback of the programs becomes possible. The program files (presentation files) are linked with the material data and the template files for playback. As a result, the displaying unit 11 plays back the material data corresponding to the program file name on the playback template. For example, when the automatic playback button b1 placed at the position of the display area 283a is linked with the program file A, the program file A can be played back by designation by clicking or selecting the automatic playback button b1 with the use of the mouse.

After the program selected from the menu screen has finished being played back, the menu screen may be displayed again or schedule playback may be executed. When the menu screen is displayed, schedule playback is executed in a case where no program is selected from the predetermined time menu screen.

In this way, the same program file can be used when carrying out schedule playback as well as menu playback. Therefore, the data amount stored in the storage unit 14 can be reduced, and the drawing power of the programs is enhanced.

The menu file and the template file for menu are not limited to one each. Rather, a plurality of them may be prepared to change the menu screen that displays for every date and time and for every place. In this case, a schedule file is created in advance to change the menu screen to be displayed for every predetermined date and time. For example, a schedule file in which a menu screen of the programs focused mainly on music information is displayed in the morning and a menu screen of the programs focused mainly on movie information is displayed in the afternoon are created in advance. As a result, the menu screens and the programs can be played back according to the dates and times and the places.

The information display device 10 and the information creating device 70 are not limited to an application of the information distribution display system. Rather, these devices may be applied to other communication systems. Moreover, a structure may also be employed in which the information creating device 70 and the information display device 10 are directly connected to each other.

According to the example described above, the programs played back by the schedule file and the programs played back by the menu file can be shared. As a result, the creation of the schedule file and the menu file can be readily carried out in a short time. Further, the schedule file and the menu file can be created with the use of the same program display priority information. As a result, the creation of the schedule file and the menu file can be readily carried out in a short time. Furthermore, the schedule file and the menu file allow the same program to be played back so that schedule playback and menu playback can be carried out with the use of a smaller number of program files. Still further, because the number of the program files is small, not only can sending and receiving the program files become easier, but also the capacity can be reduced of the storage unit 14 that stores the files to display programs.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A control information file creating device that creates a control information file to play back and display plural pieces of different display information, comprising:
a schedule file creating unit that creates as a control information file a schedule file to successively play back and display the plural pieces of display information for each piece of display information; and
a menu file creating unit that creates as a control information file a menu file to select one piece of display information from the plural pieces of display information and to play back and display the selected piece of display information, wherein the schedule file creating unit and the menu file creating unit create the schedule file and the menu file such that at least part of the display information is shared by the schedule file and the menu file.

2. The control information file creating device according to claim 1, wherein the schedule file creating unit, the menu file creating unit, or both of the schedule file creating unit and the menu file creating unit create the schedule file, the menu file, or both the schedule file and the menu file based on priority information, which includes a priority of playback and display for each piece of display information.

3. The control information file creating device according to claim 1, wherein the schedule file creating unit and the menu file creating unit create the schedule file and the menu file, respectively, at the same time.

4. The control information file creating device according to claim 1, wherein the schedule file creating unit creates a schedule file based on the menu file created by the menu file creating unit.

5. The control information file creating device according to claim 1, wherein the menu file creating unit creates a menu file based on the schedule file created by the schedule file creating unit.

6. A control information file creation method comprising:
creating a schedule file to successively play back and display plural pieces of display information and a menu file to select one piece of display information from the plural pieces of display information and to play back and display the selected piece of display information as respective control information files; and
creating the schedule file and the menu file such that at least part of the display information is shared by the schedule file and the menu file.

7. An information display device that plays back and serially displays plural pieces of different display information, comprising:
a storage unit that stores the plural pieces of display information, a schedule file to successively play back and display the plural pieces of display information based on a predetermined time setting or a predetermined order setting for each piece of display information, and a menu file that selects one piece of display information from the plural pieces of display information that are at least partly shared with the plural pieces of display information used in the schedule file and plays back and displays the selected piece of display information; and
a displaying unit that plays back and displays the plural pieces of display information based on at least one of the schedule file and the menu file.

8. An information distribution display system comprising:
a control information file creating device that creates a control information file to play back and display plural pieces of different display information; and
an information display device that plays back and displays the plural pieces of display information based on the control information file,
wherein the control information file creating device creates as control information files
a schedule file to successively play back and display the plural pieces of display information based on a predetermined time setting or a predetermined order setting for each piece of display information; and
a menu file to select one piece of display information from the plural pieces of the display information and to play back and display the selected piece of display information so that at least part of the display information is shared by the schedule file and the menu file, and
wherein the control information file creating device transmits the schedule file and the menu file to the information display device, which plays back, and displays the plural pieces of display information based on at least one of the received schedule file and the menu file.
